(19) United States
(12) Patent Application Publication
(10) Pub. No.: US 2008/0021813 A1
(43) Pub. Date: Jan. 24, 2008

(54) Method for scoring accounts for retention and marketing accounts based on retention and profitability

(75) Inventors: Steven D. Simpson, Austin, TX (US); Erik M. Hoghaug, Dripping Springs, TX (US); Allen E. Francom, Austin, TX (US)

Correspondence Address: MEYERTONS, HOOD, KIVLIN, KOWERT & GOETZEL, P.C., P.O. BOX 398, AUSTIN, TX, 78767-0398, US

(73) Assignee: Sheshunoff Management Services, LP, Austin, TX (US)

(21) Appl. No.: 11/490,675

(22) Filed: Jul. 21, 2006

(51) Int. Cl. G06Q 40/00

(52) U.S. Cl. 705/38

(57) ABSTRACT

In one embodiment, a computer accessible medium stores a plurality of instructions which, when executed: receive account data corresponding to a plurality of accounts at a financial institution; and generate a retention score for each account. The retention score comprises a numerical value that indicates a relative likelihood of retention of that account by the financial institution. In some embodiments, the retention score also comprises a component indicator field that indicates one or more components that are affecting the numerical value. In one embodiment, the numerical value of the retention score may be used to affect an overdraft limit for the account. Some embodiments generate a profit score for each account, and divide the plurality of accounts into subsets based on the retention/profit scores. Different subsets may have different marketing strategies. Retention scores calculated before and after a marketing campaign may be used to evaluate the campaign.

### BACKGROUND

1. Field of the Invention

This invention is related to software for financial institutions.

2. Description of the Related Art

Financial institutions are organizations which provide various account services for their customers, serving their customer's financial needs. Financial institutions may include banks, credit unions, savings and loan associations, lending institutions, etc. Financial institutions offer a variety of accounts and services, such as demand-deposit accounts (e.g. checking, savings, and money-market), time deposit accounts (e.g. certificates of deposit, or CDs), loans, etc.

Financial institutions earn profits from borrowing money at low rates (e.g. from depositors) and lending the money at higher rates or investing the money for a higher return. The difference in the interest rate paid to depositors and the interest rate charged on loans or earned on investments is referred to as the “net interest margin”. Additionally, financial institutions generate fee income for providing various services and/or account features.

In order to generate more profits, financial institutions must acquire new accounts/deposits to lend and invest more. A certain amount of money must be invested to acquire each new account (e.g. general marketing expenses such as billboards, print and media advertisements, the employee's time spent opening the account, etc.). However, there is also turnover in the new accounts. Currently, approximately 35-45% of new accounts at a given financial institution will not last for a full year. That is, the customer that opened the account will close the account before the account is a year old. The financial institution does not earn profits on most of these accounts, as they have not been open long enough to recoup the acquisition costs.

The financial institution attempts to stem the loss of new accounts by marketing other accounts and services to these new customers or new account holders. By creating additional ties to a given customer, the financial institution can reduce the rate of account loss. However, efforts in this realm are crude and broad-based. For example, a financial institution may commit to spending a fixed amount of dollars per account per year to market to that account, and may spend those dollars on the same marketing campaigns for each account. In some cases, the bank may have different account types and may market to those different account types differently.

### SUMMARY

In one embodiment, a computer accessible medium stores a plurality of instructions which, when executed: receive account data corresponding to a plurality of accounts at a financial institution; and generate a retention score for each account. The retention score comprises a numerical value that indicates a relative likelihood of retention of that account by the financial institution as compared to other accounts of the plurality of accounts. In some embodiments, the retention score further comprises a component indicator field that indicates one or more components used to generate retention scores. The component indicator field identifies which components are affecting the numerical value.

In another embodiment, the instructions, when executed, generate an overdraft limit for each account. The overdraft limit of a given account is the net amount that the financial institution will permit the given account to be overdrawn, and the overdraft limit for the given account is dependent on the retention score of the given account.

In an embodiment, the instructions, when executed, also generate a profit score for each account. The profit score is a measure of profitability of the account. The instructions, when executed, divide the accounts into subsets based on the retention scores and profit scores of each account; and market to a given account of the plurality of accounts responsive to the subset in which the given account is found.

In an embodiment, the computer accessible medium comprises instructions which, when executed, scan the retention scores to eliminate accounts from consideration for a marketing campaign directed to at least one of the components. The eliminated accounts have corresponding retention scores that include a component indicator field indicating that the corresponding numerical value would not be substantially affected by customer acceptance of the marketing campaign. Remaining accounts not eliminated by the scan are candidates for the marketing campaign.

### BRIEF DESCRIPTION OF THE DRAWINGS

The following detailed description makes reference to the accompanying drawings, which are now briefly described.

FIG. 1 is a block diagram of one embodiment of a system including a profit scorer, a retention scorer, an overdraft scorer, and a marketing engine is shown.

FIG. 2 block diagram of one embodiment of a retention score.

FIG. 3 is a graph illustrating retention and profit scores.

FIG. 4 is a flowchart illustrating operation of one embodiment of an overdraft scorer.

FIG. 5 is a flowchart illustrating operation of one embodiment of a retention scorer.

FIG. 6 is a flowchart illustrating operation of one embodiment of a profit scorer.

FIG. 7 is a flowchart illustrating operation of one embodiment of a marketing engine for initiating a marketing campaign.

FIG. 8 is a flowchart illustrating operation of one embodiment of a marketing engine for evaluating a marketing campaign.

FIG. 9 is a block diagram of one embodiment of a computer accessible medium.

FIG. 10 is a block diagram of one embodiment of a computer system.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION OF EMBODIMENTS

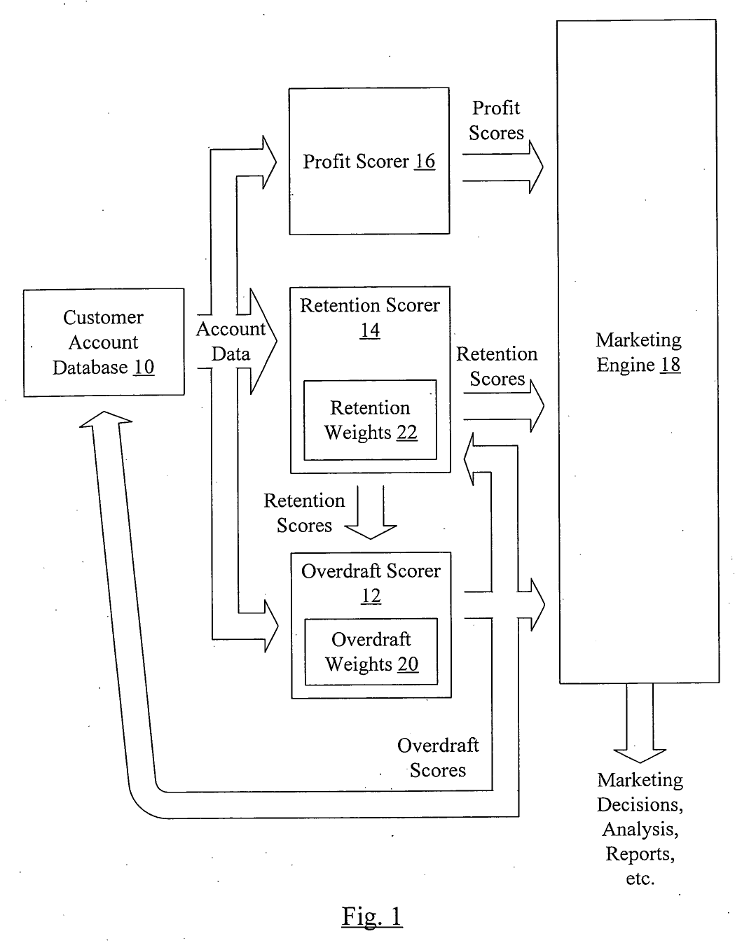

Turning now to FIG. 1, a block diagram of one embodiment of a system for generating overdraft limits, retention scores, and profit scores for the accounts of a financial institution is shown. In the embodiment of FIG. 1, a customer account database 10, an overdraft scorer 12, a retention scorer 14, a profit scorer 16, and a marketing engine 18 are shown. The overdraft scorer 12 may include a set of overdraft weights 20 and the retention scorer 14 may include a set of retention weights 22. Various information flowing between the customer account database 10, the scorers 12, 14, and 16, and the marketing engine 18 are shown via arrows from source to destination. Each of the scorers 12, 14, and 16, and the marketing engine 18, may comprise one or more program modules. Each program module may comprise a plurality of instructions executable to perform the operations defined for that module as described herein. Various ones of the scorers 12, 14, 16, and the marketing engine 18 may be incorporated into the same module, in other embodiments.

The customer account database 10 may be maintained by the financial institution or a financial institution service provider, and may be updated as new accounts are opened and/or customer transactions are processed. For example, the customer account database 10 may include data identifying each account, as well as account activity data such as deposits, withdrawals, checks cleared, interest earned or charged, fees charged, etc. The account data may also include other information, such as the overdraft score, retention score, and/or profit score for each account. For brevity, the financial institution will be referred to in this description as a “bank”, but any financial institution may implement the system described herein in various embodiments.

The scorers 12, 14, and 16 and the marketing engine 18 may also be located at the bank. For example, the scorers 12, 14, and 16 and the marketing engine 18 may be installed on a computer or computers at the bank, either the same computer that stores the customer account database 10 or a different computer or computers. Alternatively, one or more of the scorers 12, 14, 16 and/or the marketing engine 18 may be located elsewhere, such as at a consultant or other bank service provider. In some embodiments, the account identifiers provided in the account data may not be the actual account numbers used by customers and the bank to process transactions, for security reasons. For example, a hash function or other reversible data manipulation operation may be applied to each account number to generate the account identifier. As long as each account identifier is unique to the corresponding account within the account data, any identifier may be used.

The retention scorer 14 receives the account data and generates a retention score for each account. The retention score may be an indication of the likelihood that the account will be retained by the financial institution. That is, the retention score indicates how likely it is that the account will remain open with the final institution in the future. The retention score may have various components, each of which may have a correlation to account retention. For example, the occurrence of a component may be correlated with account retention (or may be negatively correlated, in some instances). For some components, the number of occurrences in a given period of time, such as a month, may be correlated to account retention. Still other components may have both occurrence and number of occurrences correlated to account retention. In some embodiments, the retention scorer 14 may also receive data, such as the overdraft scores, from the overdraft scorer 12 as well.

In one embodiment, statistical analysis may be performed to determine which components should be included in generation of the retention score as well as the relative weights 22. The weights may be values assigned to the components, such that the occurrence of the component causes the corresponding value to be added to the score. For components that measure frequency, the weight may be multiplied by the number of occurrences. In some embodiments, statistical analysis may be performed periodically on the account database 10 to correlate components to the retention experience at a particular bank or bank branch, and the analysis may be performed by the retention scorer 14. In other embodiments, statistical analysis may be performed as part of developing the initial set of weights 22 that may be supplied with the retention scorer 14. The weights may be updated at a later time, if desired, either manually or through additional statistical analysis.

The retention scorer 14 may search the account data for each account to detect the components, and may generate the score based on the detected components. For example, the components may include various account services, frequency of use (or volume) of the account services, other accounts for the same customer, age of the account, etc.

By scoring each account for retention, the bank may gain insight into which accounts are exhibiting behaviors that generally lead to retention of the account and/or which accounts are exhibiting behaviors that generally lead to closing of the account, in one embodiment. Thus, for example, in the first year that an account is open, banks may be given more insight into which accounts are more likely to have high retention, relative to other accounts. The uses for such data are myriad. The banks may use the retention scores to identify accounts that are more likely to be retained, and may more heavily market to those accounts than to accounts that are less likely to be retained, using marketing budget that would otherwise be used for the less retainable accounts. Or, the scores may be used in the opposite fashion, attempting to build more retentive characteristics with accounts that are more likely to close. A bank may have a retention score goal for each account, and may attempt to reach that goal. The marketing engine 18 may thus receive the retention scores for each account, and may use the retention scores in formulating marketing decisions, marketing analysis, various reports for management, etc.

In some embodiments, the retention scorer 14 may also be used as evidence for government bank examiners, who ensure that a bank is meeting regulations requiring the matching of bank assets (loans, investments) to bank liabilities (deposit accounts). Accounts that are not governed by a contract requiring that the deposit remain in the bank for a fixed period of time (e.g. checking, savings, and money market accounts typically have no such contract) are considered short term liabilities and mostly are matched to short term assets. However, if a bank can demonstrate that a higher retention score correlates to longer term deposits, the bank may be permitted to balance a higher percentage of deposits against longer term assets. The net interest margin may thus be increased (by paying short term interest rates on the deposits while loaning money at long term interest rates). Increasing the net interest margin may increase profits. In addition or alternatively, deposits may be balanced against longer term investments, or the bank may pay higher short term interest rates to attract more deposits.

The retention scorer 14 may also be used, in some embodiments, to measure the effectiveness of various marketing campaigns. By generating the retention scores before and after the campaign and comparing them, the effectiveness of the campaign may be gauged. Different campaigns may be compared for relative effectiveness, and ineffective campaigns or relatively ineffective campaigns may be discontinued or modified. Again, the marketing engine 18 may perform such effectiveness measuring, using previously generated retention scores and current retention scores from the retention scorer 14. Previously generated retention scores may be obtained from the customer account database 10, if stored there, or may be stored separately by the marketing engine 18.

In various embodiments, the components used in the retention score may include one or more of the following components (and/or other desired components): whether or not the account has automated clearing house (ACH) credits; whether or not an account has ACH debits; number of ACH debits/credits per month; whether or not Internet banking is used; number of Internet banking logons per month; whether or not electronic bill payment is used; number of bills paid electronically per month; whether or not the customer uses a voice response unit (VRU) to check the account; number of VRU accesses per month; whether or not the customer has multiple accounts (loans, checking, savings, certificates of deposit (CDs)), types of accounts; numbers of accounts; age of the account; number of transactions per month; ties to a pay-day lender; whether or not the account has debit card transactions; number of debit card transactions per month; and type of debit card transactions (signature or personal identification number (PIN) transactions). The “whether or not” components are tests for existence of the component: the retention score may be increased by a specified amount if the component is detected. The “number of” components are frequency/volume components. Score increase may be tied to the number of occurrences. For example, the number may be multiplied by a given value to generate the amount of score increase, or score thresholds may be tied to ranges of the frequency/volume.

Most of the above factors may be indicative of account retention. For example, arranging ACH deposits generally involves a certain amount of effort on the part of the customer (e.g. with the customer's employer, to have pay checks deposited via ACH). Similarly, arranging ACH debits for recurring expenses such as insurance payments, mortgage payments, utility payments, etc. generally involves the customer making arrangements with each vendor. To change to another account, such as at another bank, would require the customer to make similar arrangements. Increased numbers of such ACH transactions may thus also be indicative of retention, since arrangement efforts are needed for each one. The use of Internet banking or VRU, and frequent use, may indicate retention since the customer becomes familiar with the bank's web site/VRU, and other bank's web sites/VRUs differ. Use of electronic bill payment (initiated at the bank, as opposed to ACH transactions which are initiated at various vendors) similarly involves the customer inputting account numbers, addresses of vendors, etc., that would have to be repeated at other banks. Having multiple accounts may indicate retention since the customer is purchasing other products from the bank, and thus is probably enjoying the benefits of the bank relationship. Additionally, moving multiple accounts to another bank is more time consuming than moving one account. The types of accounts may indicate retention. A loan account can not be closed until the loan is paid in full. Similarly, a CD account typically includes penalties for early withdrawal, and thus will not often be closed until the CD term ends. As an account ages, it becomes more likely to be retained. Additionally, a heavily used account (numerous transactions, numerous debit card transactions) is more likely to be retained, as many transactions are outstanding at any given point in time.

In one embodiment, the retention score's numerical value may be relative. That is, the retention score of one account may be compared to the retention scores of other accounts to determine which accounts have higher likelihood of retention. For example, one account having a retention score of 200 may be twice as likely to be retained as another account having a retention score of 100.

A feature offered by many banks on checking accounts is an overdraft privilege. The overdraft privilege permits the customer to overdraw the account, causing a negative balance. The institution pays the item that causes the overdraft, and may charge a fee. By permitting the customer to overdraw the account (e.g. by presenting a check for which there are not sufficient funds in the checking account to pay the check, referred to as an NSF check), the customer may avoid the extra fees and inconvenience incurred when the check is returned to the presenter. For example, the presenter (e.g. the entity to which the check is written) may charge additional fees or even file criminal charges against the customer if the check is returned. If the customer overdrafts the account, a fee can be generated. The bank may inform the customer of the overdraft, and the customer may be expected to restore the balance to a positive or zero amount relatively quickly. Features like the overdraft privilege, while generating fee income, also entail the risk that the customer will not or cannot restore the balance in the account. If the customer cannot restore the balance, the bank eventually cancels the debt (a “charge-off” event). To control the risk and loss of profits that the overdraft privilege entails, banks typically set limits on the overdraft privilege (“overdraft limits”).

The overdraft scorer 12 may be configured to analyze the account data and/or previous overdraft scores to generate an overdraft score for each account and to update the factors used in the equations to generate the overdraft scores (e.g. equation weights). Specifically, as shown in FIG. 1, the overdraft scorer 12 may receive the account data and may use previously-generated equation weights 20 to generate an overdraft score for each account. The overdraft score may be a dollar amount of overdraft limit for the corresponding account. Alternatively, the overdraft score may be converted to an overdraft limit according to a bank-specific conversion table. The equation weights may include weights for various account data as well as weights for statistical measures generated by the overdraft scorer 12 from the account data (e.g. standard deviation, mean, median, mode, sum of occurrences of a given account data item, number of occurrences of a given account data item, maximum and minimum values for a given account data item, trends in the account activity or data item, etc.). For example, the equation weights may include or be generated from correlation coefficients from logistic regressions and/or chi-squared values.

The overdraft score (and thus the overdraft limit, directly or indirectly) that is generated by the overdraft scorer 12 for each account may be affected by that account's retention score (received from the retention scorer 14 as shown in FIG. 1). The more retentive an account is, the less risky it is to extend overdraft privileges. An account that is going to remain open is more likely to be made whole by the customer than an account the customer will be closing. Accordingly, the overdraft scorer 12 may be configured to increase the overdraft score that would otherwise be applied to an account if that account's retention score is high, or decrease the overdraft score that would otherwise be applied to the account if that account's retention score is low. The overdraft scorer 12 may multiply the retention score by a programmable factor to produce the added amount, or may have ranges of retention score that map to a given dollar amount (positive or negative). The dollar amounts may be programmable as well.

In one embodiment, each account data item used in the equation to generate the overdraft score is converted to a dollar amount specified by the bank, and the dollar amounts may be weighted according to the equations weights and summed to generate the overdraft score for each account. For example, the bank may assign a dollar amount to a range of value of the account data item, and the dollar amounts assigned for a given account data item may also vary based on the length of time that the account has been open. An account data item, as used herein, may comprise any account data value (provided from the customer account database 10) or a value derived from the account data (e.g. statistical measures derived from the data). In addition, various overrides may be specified. For example, a maximum overdraft limit may be specified by a bank, which may function as a cap to the overdraft limit calculated by the statistical analyzer 12. In one embodiment, the overdraft scorer 12 may comprise the Deposit Score® product from Sheshunoff Management Services, LP.

In one particular embodiment, the overdraft scorer 12 may also execute various statistical analysis algorithms on the account data to generate updated equation weights for the scorer. For example, in one embodiment, the statistical analyzer 14 may perform logistic regression and chi-squared analysis to identify which variables are most strongly correlated to charge-off events and/or fee revenue events for each account. Based on the correlation results, the equation weights may be generated to more heavily weight the variables that are more strongly correlated to (or most strongly predictive of) the corresponding event. Relative weights may be generated based on the relative chi-squared values generated for each account data item. For example, the ratio of the chi-squared value for a given account data item to the sum of the chi-squared values for all account data items may specify the relative weight for the given account data item. Account data items that have little or no predictive value (as indicated by the statistical analysis) may be eliminated from the equation (e.g. by setting the corresponding equation weights to zero). Other embodiments may not include these features and may instead generate overdraft scores from relatively static equation weights.

The profit scorer 16 receives the account data and generates a profit score for each account. The profit score may be a measure of profitability of the account. The profit score may be a dollar amount that directly indicates the profitability (e.g. a positive or negative dollar amount per month, year, or other desired interval). Alternatively, the profit score may be a number that is not directly the dollar amount of profits, but may still be used to make meaningful comparisons to other profit scores for other accounts.

In one embodiment, the profit score may be the sum of fees and (negative) expenses for the account. Thus, components of the profit score may include one or more of the following, as well as any other desired components: fee income (e.g. from NSF activity, service charges, etc., minus waived fees); based on the average 30 day balance at the end of the month, an estimate of the income from net interest margin; interchange income associated with debit card transactions less switch fees for automated teller machine (ATM) or POS transactions; less some direct costs for statements, check processing and other operational items; and less an allocation of fixed costs or indirect costs spread over all accounts.

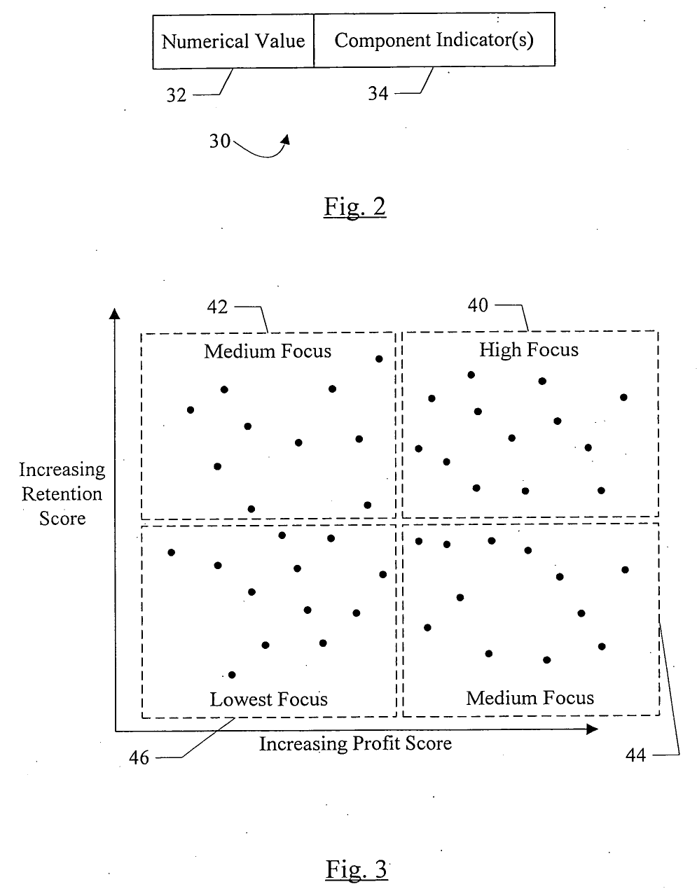

Turning next to FIG. 2, a block diagram of one embodiment of a retention score 30 is shown. In the illustrated embodiment, the retention score 30 comprises a numerical value 32 and component indicator field 34. The numerical value 32 may be the value that the retention scorer 14 generates from the detected retention score components. The component indicator field 34 may be an indication of the components. The indication may be coded in any desired form. For example, the indication may be letter codes (one or more alphanumeric symbols per component). Alternatively, the indication may be a bit field with a bit assigned to each component, which could be set or cleared based on the detection of that component. Any indication may be used. The indication may list the set of components that were detected and thus contributed to the retention score. Alternatively, the indication may list the set of components that were not detected, and thus did not contribute to the retention score. Viewed in another way, the indication may list the set of components that, if added to the account, would generate a higher retention score. In still another embodiment, the indication may list a set of components that dominate the retention score (e.g. the N largest contributors to the retention score, where N is a positive integer). Generally, the indication may identify the components that affect the retention score (e.g. positively or negatively, directly or indirectly).

Providing component indications as part of the retention score 30 may permit the classification of retention scores into different groups, in one embodiment. For example, two retention scores with the same numerical value 32 may have different component indicator fields 34, and thus the two retention scores may be viewed differently based on the components that make up the retention scores. The classifications may also be used to more effectively market to the accounts, as will be highlighted in more detail below.

Turning now to FIG. 3, a graph is shown illustrating retention score on the vertical axis and profit score on the horizontal axis. Various accounts are plotted as points on the graph, based on their retention and profit scores. FIG. 3 illustrates how, in one embodiment, the combination of retention score and profit score for a set of accounts could be used to stratify the bank's accounts into subsets. For example, the bank could focus its marketing efforts on the most profitable, highest retentive accounts (illustrated by dotted box 40 in FIG. 3). A medium level of focus could be on the high retentive, low profit accounts (with an emphasis on making them more profitable), and/or on the low retentive, high profit accounts (with an emphasis on making them more retentive). These subsets are illustrated by dotted boxes 42 and 44, respectively. The lowest focus could be on the low retentive, low profit accounts (dotted box 46).

For example, the bank may focus marketing efforts by allocating more marketing expenditure to the higher focus groups at the expense of the lower focus groups. Some banks may choose to focus more efforts on the high profit, low retentive accounts (box 44) as opposed to the high retentive, low profit accounts (box 42) while others may choose the opposite or equally focus on both subsets.

Additionally, efforts may differ for the different subsets. For example, highly profitable, highly retentive accounts (box 40) may have a private banker assigned to them early in the age of the account (e.g. at 6 months), or other account features that the bank offers to older accounts may be activated earlier. Efforts in the high retentive, low profit subset (to increase profit) may differ from efforts in the high profit, low retentive subset (to increase retention). Furthermore, which subset a given account falls into may affect other decisions at a bank. For example, if a customer requests that fees be waived, the decision may be based on which subset the customer's account falls into (e.g. yes for box 40 or 42, no for box 44 or 46; or yes for boxes 40, 42, and 44 but no for box 46).

Generally, the combination of profit score and retention score may be used to select different marketing strategies for different accounts and/or determine how much marketing resources are devoted to each account, possibly at the expense of marketing resources from other accounts in other subsets. That is, the marketing to each account may vary based on the profit scores and retention scores for the accounts at the financial institution.

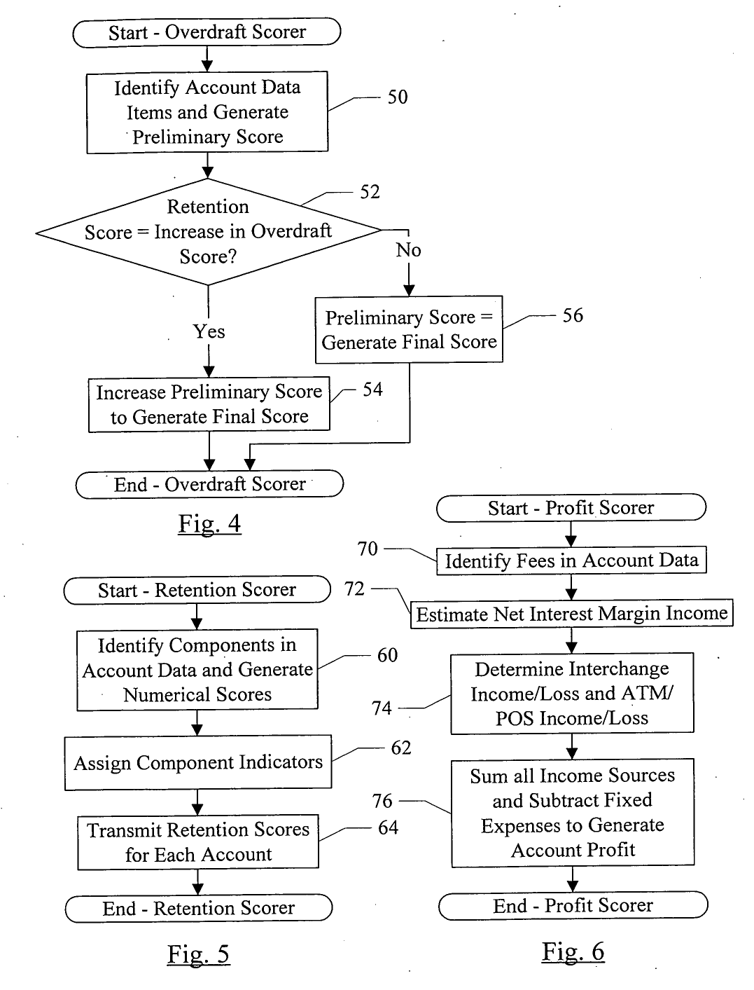

Turning next to FIG. 4, a flowchart is shown illustrating operation of one embodiment of the overdraft scorer 12. While the blocks are shown in a particular order for ease of understanding, other orders may be used. The overdraft scorer 12 may comprise instructions which, when executed, implement the operation of the flowchart shown.

The overdraft scorer 12 receives the account data, and may identify account data items in the account data to generate a preliminary overdraft score (block 50). The overdraft scorer 12 may also receive the retention scores for the accounts from the retention scorer 14. The overdraft scorer 12 may determine, for each account, if the retention score for that account indicates that the overdraft limit should be increased (decision block 52). If so (decision block 52, “yes” leg), the overdraft scorer 12 may increase the preliminary score to generate the final overdraft score output to the marketing engine 18 and the customer account database 10 (block 54). If not (decision block 52, “no” leg), the overdraft scorer 12 may output the preliminary score as the final score (block 56).

As mentioned above, other embodiments may be configured to decrease the preliminary score for low retention scores, or may be configured to both increase the preliminary score for high retention scores and decrease the preliminary score for low retention scores (while not modifying the preliminary score for medium retention scores).

Turning now to FIG. 5, a flowchart is shown illustrating operation of one embodiment of the retention scorer 14. While the blocks are shown in a particular order for ease of understanding, other orders may be used. The retention scorer 14 may comprise instructions which, when executed, implement the operation of the flowchart shown.

The retention scorer 14 may scan the account data to identify components of the retention score in the account data, and may generate numerical scores for each account (block 60). The scanning may include accumulating occurrences for components that measure volume/frequency of account services, as well as detecting the existence of account services and other data for components that measure whether or not an account service is used. The retention scorer 14 may also assign the component indictors for each retention score, creating the component indicators field 34 for each score (block 62). The retention score 14 may transmit the retention scores for each account (e.g. to the overdraft scorer 12, the customer account database 10, and/or the marketing engine 18, in various embodiments) (block 64).

Turning now to FIG. 6, a flowchart is shown illustrating operation of one embodiment of the profit scorer 16. While the blocks are shown in a particular order for ease of understanding, other orders may be used. The profit scorer 16 may comprise instructions which, when executed, implement the operation of the flowchart shown.

The profit scorer 16 may scan the account data to identify fees in the account data (block 70), as well as estimating income from the net interest margin and the balance information (block 72). For example, the average collected balance may be multiplied by the net interest margin to generating the estimated net interest margin income. The profit scorer 16 may determine the net income or loss from the interface fees (block 74) and may sum all income sources (e.g. blocks 70 and 72) and subtract expenses (e.g. block 74 and fixed expenses) to generate the profit score (block 76). The profit scorer 16 may output the profit scores (e.g. to the marketing engine 18 and/or the customer account database 10, in various embodiments).

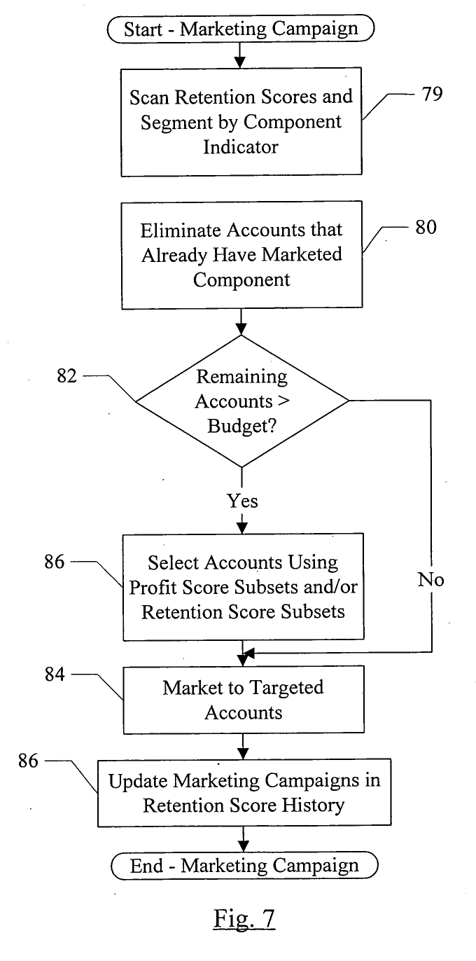

Turning now to FIG. 7, a flowchart is shown illustrating operation of one embodiment of the marketing engine 18 to identify targeted accounts for a specific marketing campaign. While the blocks are shown in a particular order for ease of understanding, other orders may be used. The marketing engine 18 may comprise instructions which, when executed, implement the operation of the flowchart shown.

The marketing campaign may be marketing a specific component or components of the retention score (e.g. a specific account service, or an increased frequency of a specific account service). For example, the marketing campaign may include a brochure to be mailed, a phone campaign in which employees call customers to pitch a service, electronic campaigns such as an email to the targeted group, a combination of the above, etc. Accounts which already have the component represented in their retention score would not be targeted by the marketing campaign, or might be targeted to increase the component, in some embodiments. The marketing engine 18 may scan the retention scores for the accounts and may segment the scores by component indicator (block 79). The marketing engine 18 may eliminate accounts that already have the marketed component or components, or that have the component in a sufficient frequency that marketing is not desired to that account (block 80). The list of remaining accounts are a preliminary target list.

The marketing engine 18 may determine whether or not the number of the remaining accounts fits within the marketing budget for the campaign (decision block 82). For example, the marketing campaign may have a cost per account, and that cost multiplied by a number of the remaining accounts may be compared to the budget. If the number of remaining accounts fits within the budget (decision block 82, “no” leg), the remaining accounts are the targeted accounts and the marketing campaign may proceed (block 84). On the other hand, if the number of remaining accounts would exceed the budget (decision block 82, “yes” leg), the marketing engine 18 may rank the remaining accounts using the profit score/retention score subsets (e.g. as shown in FIG. 3, in one embodiment) to select accounts from the remaining accounts to be the targeted accounts (block 86). The marketing campaign may then proceed for the targeted accounts (block 84). The marketing campaigns may also be updated in the retention score history, logging which marketing campaigns were used for which accounts (block 86).

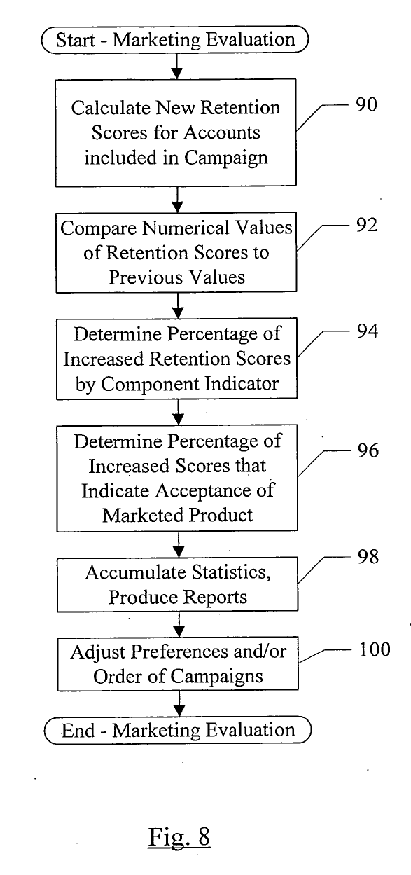

Turning now to FIG. 8, a flowchart is shown illustrating operation of one embodiment of the marketing engine 18 to evaluate a marketing campaign. For example, the evaluation may occur when the marketing campaign is considered concluded, such as at the end of a special offer period, after a phone campaign is completed, or at some designated point in time after a brochure mailing. While the blocks are shown in a particular order for ease of understanding, other orders may be used. The marketing engine 18 may comprise instructions which, when executed, implement the operation of the flowchart shown.

The marketing engine 18 may call the retention scorer 14 to calculate new retention scores for all accounts, or only for the accounts included in the campaign (block 90). Alternatively, the marketing engine 18 may receive the retention scores from the next regular execution of the retention scorer 14 after the conclusion of the campaign. The marketing engine 18 may have retained the retention scores from prior to the campaign, or they may be available in the customer account database 10 or some other database. The marketing engine 18 may compare the numerical values of the past and current retention scores (block 92), and may determine various statistics (e.g. percentage of increased scores, average increase, minimum and maximum increase, number of scores exceeding a desired threshold, etc.). Particularly, in the illustrated embodiment, the marketing engine 18 may determine the percentage of increased retention scores (over all accounts and/or over the targeted accounts) (block 94). The percentage may be calculated by component indicator as well. Additionally, the marketing engine 18 may examine the component indicator fields 34 to determine how many increased scores indicate acceptance of the marketed component (block 96). The various statistics may be accumulated and a report produced for review to determine the effectiveness of the campaign (block 98). In some embodiments, the marketing engine 18 may also be configured to evaluate the statistics against predetermined measures (e.g. set by management) to rank a given campaign as a success (to be repeated) or failure (not to be repeated or to be modified). The campaign preferences may be adjusted based on the evaluation, and/or the order of campaigns (if multiple campaigns have been run) may be adjusted (block 100). Adjustments may be based on higher acceptance, higher profitability of the accounts that accepted, etc.

It is noted that, in some embodiments, the retention score, overdraft score, and/or profit score may be generated at discrete times, by scanning the account data associated with a set of accounts at those discrete times. Other embodiments may update one or more of the above score in real time, as transactions occur. Still other embodiments may implement score generation at other points along the spectrum between discrete times and real times.

Turning now to FIG. 9, a block diagram of a computer accessible medium 300 is shown. Generally speaking, a computer accessible medium may include any media accessible by a computer during use to provide instructions and/or data to the computer. For example, a computer accessible medium may include storage media. Storage media may include magnetic or optical media, e.g., disk (fixed or removable), tape, CD-ROM, or DVD-ROM, CD-R, CD-RW, DVD-R, DVD-RW. Storage media may also include volatile or non-volatile memory media such as RAM (e.g. synchronous dynamic RAM (SDRAM), Rambus DRAM (RDRAM), static RAM (SRAM), etc.), ROM, or Flash memory. Storage media may include non-volatile memory (e.g. Flash memory) accessible via a peripheral interface such as the Universal Serial Bus (USB) interface in a solid state disk form factor, etc. The computer accessible medium may include microelectromechanical systems (MEMS), as well as media accessible via transmission media or signals such as electrical, electromagnetic, or digital signals, conveyed via a communication medium such as a network and/or a wireless link. The computer accessible medium 300 in FIG. 9 may store one or more of the customer account database 10, marketing engine 18, the profit scorer 16, the retention scorer 14, the overdraft scorer 12, the overdraft weights 20, the retention weights 22, the profit scores 302, the overdraft scores 304, and the retention scores 306. The various software may comprise instructions which, when executed, implement the operation described herein for the respective software. Generally, the computer accessible medium 300 may store any set of instructions which, when executed, implement a portion or all of the flowcharts shown in one or more of FIGS. 4, 5, 6, 7, and 8.

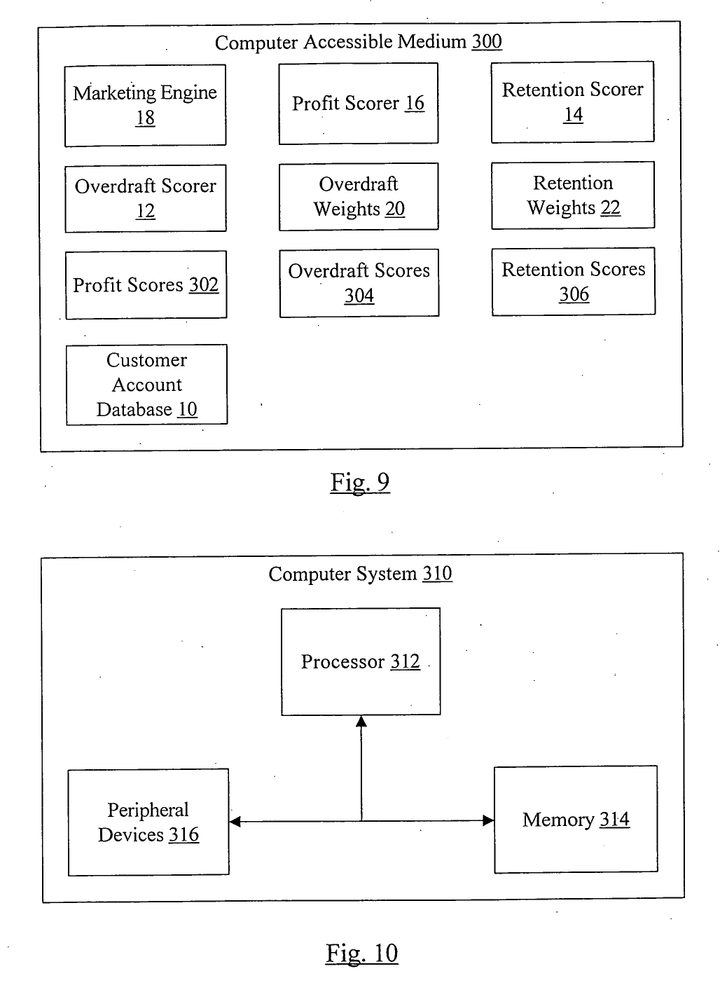

FIG. 10 is a block diagram of one embodiment of an exemplary computer system 310. In the embodiment of FIG. 10 the computer system 310 includes a processor 312, a memory 314, and various peripheral devices 316. The processor 312 is coupled to the memory 314 and the peripheral devices 316.

The processor 312 is configured to execute instructions, including the instructions in the software described herein, in some embodiments. In various embodiments, the processor 312 may implement any desired instruction set (e.g. Intel Architecture-32 (IA-32, also known as x86), IA-32 with 64 bit extensions, x86-64, PowerPC, Sparc, MIPS, ARM, IA-64, etc.). In some embodiments, the computer system 310 may include more than one processor.

The processor 312 may be coupled to the memory 314 and the peripheral devices 316 in any desired fashion. For example, in some embodiments, the processor 312 may be coupled to the memory 314 and/or the peripheral devices 316 via various interconnect. Alternatively or in addition, one or more bridge chips may be used to couple the processor 312, the memory 314, and the peripheral devices 316, creating multiple connections between these components.

The memory 314 may comprise any type of memory system. For example, the memory 314 may comprise DRAM, and more particularly double data rate (DDR) SDRAM, RDRAM, etc. A memory controller may be included to interface to the memory 314, and/or the processor 312 may include a memory controller. The memory 314 may store the instructions to be executed by the processor 312 during use (including the instructions implementing the software described herein), data to be operated upon by the processor 312 during use, etc.

Peripheral devices 316 may represent any sort of hardware devices that may be included in the computer system 310 or coupled thereto (e.g. storage devices, optionally including a computer accessible medium 300, other input/output (I/O) devices such as video hardware, audio hardware, user interface devices, networking hardware, etc.). In some embodiments, multiple computer systems may be used in a cluster.

Numerous variations and modifications will become apparent to those skilled in the art once the above disclosure is fully appreciated. It is intended that the following claims be interpreted to embrace all such variations and modifications.

What is claimed is:

1. A computer accessible medium storing a plurality of instructions which, when executed:
receive account data corresponding to a plurality of accounts at a financial institution; and
generate a retention score for each account of the plurality of accounts, wherein the retention score comprises a numerical value that indicates a relative likelihood of retention of that account by the financial institution as compared to other accounts of the plurality of accounts, and wherein the retention score further comprises a component indicator field that indicates one or more components used to generate retention scores, wherein the component indicator field identifies which components are affecting the numerical value.

2. The computer accessible medium as recited in claim 1 wherein the component indicator field indicates the components that were detected during generation of the retention score that caused the numerical value to increase.

3. The computer accessible medium as recited in claim 2 wherein the components indicated in the component indicator field are the dominant components causing the largest increases in the numerical value.

4. The computer accessible medium as recited in claim 1 wherein the component indicator field indicates the components that were not detected during generation of the retention score, and did not contribute to the generation of the numerical value.

5. The computer accessible medium as recited in claim 1 wherein the components comprise account services.

6. The computer accessible medium as recited in claim 5 wherein the components further comprise frequency of use of account services.

7. A computer accessible medium storing a plurality of instructions which, when executed:
generate a retention score for each of a plurality of accounts at a financial institution, wherein the retention score is indicative of a relative likelihood of retention of that account by the financial institution as compared to other accounts of the plurality of accounts; and
generate an overdraft limit for each account of the plurality of accounts, wherein the overdraft limit of the given account is the net amount that the financial institution will permit the given account to be overdrawn, and wherein the overdraft limit for the given account is dependent on the retention score of the given account.

8. The computer accessible medium as recited in claim 7 wherein the instructions, when executed, assign higher overdraft limits to accounts whose retention scores indicate higher likelihood of retention.

9. The computer accessible medium as recited in claim 7 wherein the instructions, when executed, assign lower overdraft limits to accounts whose retention scores indicate lower likelihood of retention.

10. The computer accessible medium as recited in claim 7 wherein the instructions, when executed, modify the overdraft limit by a fixed amount dependent on one or more threshold levels defined in the retention score range and a numerical value of the retention score.

11. A computer accessible medium storing a plurality of instructions which, when executed:
generate a retention score for each of a plurality of accounts at a financial institution, wherein the retention score is indicative of a relative likelihood of retention of that account by the financial institution as compared to other accounts of the plurality of accounts;
generate a profit score for each account of the plurality of accounts, wherein the profit score is a measure of profitability of the account; and
divide the plurality of accounts into subsets based on the retention scores and profit scores of each account, the subsets usable to guide differing marketing efforts for various accounts of the plurality of accounts.

12. The computer accessible medium as recited in claim 11, wherein the differing marketing efforts comprise allocating a large portion of marketing expenditures on the subset having high retention scores and the high profit scores.

13. The computer accessible medium as recited in claim 12 wherein the different marketing efforts comprise allocating a lesser portion of marketing expenditures on the subset having the high retention scores but lower profit scores.

14. The computer accessible medium as recited in claim 12 wherein the different marketing efforts comprise allocating a lesser portion of marketing expenditures on the subset having lower retention scores but high profit scores.

15. The computer accessible medium as recited in claim 12 wherein the wherein the different marketing efforts comprise allocating a lesser portion of marketing expenditures on the subset having lower retention scores and lower profit scores.

16. A computer accessible medium storing a plurality of instructions which, when executed:
generate a retention score for each of a plurality of accounts at a financial institution, wherein the retention score comprises a numerical value that indicates a relative likelihood of retention of that account by the financial institution as compared to other accounts of the plurality of accounts, and wherein the retention score further comprises a component indicator field that indicates one or more components used to generate retention scores, wherein the component indicator field identifies which components are affecting the numerical value; and
scan the retention scores to eliminate accounts from consideration for a marketing campaign directed to at least one of the components, wherein the eliminated accounts have corresponding retention scores that include a component indicator field indicating that the corresponding numerical value would not be substantially affected by customer acceptance of the marketing campaign, and wherein remaining accounts not eliminated by the scan are candidates for the marketing campaign.

17. The computer accessible medium as recited in claim 16 wherein the marketing campaign has a budget and wherein, if the budget is sufficient to market to all remaining accounts, the plurality of instructions, when executed, select all of the remaining accounts for the marketing campaign.

18. The computer accessible medium as recited in claim 17 wherein, if the budget is insufficient, the plurality of instructions, when executed, select accounts from the remaining accounts.

19. The computer accessible medium as recited in claim 18 wherein the plurality of instructions, when executed, generate a profit score for each account and the selected accounts are accounts from the remaining accounts that have higher profit scores than the other remaining accounts.

20. The computer accessible medium as recited in claim 16 wherein the plurality of instructions, when executed after conclusion of the marketing campaign:
generate new retention scores for at least targeted accounts that were marketed to in the marketing campaign; and
compare the new retention scores to the previous retention scores for the targeted accounts to measure effectiveness of the campaign.

21. The computer accessible medium as recited in claim 20 wherein the plurality of instructions, when executed, determine customer acceptance using the component indicator fields to measure the effectiveness of the campaign.

22. The computer accessible medium as recited in claim 20 wherein the plurality of instructions, when executed, compare numerical value changes in the new and previous retention scores to measure the effectiveness of the campaign.
